(19) United States
(12) Patent Application Publication
(10) Pub. No.: US 2013/0066657 A1
(43) Pub. Date: Mar. 14, 2013

(54) SYSTEM AND METHOD FOR ANALYZING EXISTING AND POTENTIAL LIFE INSURANCE COVERAGE

(71) Applicant: Joshua Paul Jenkins-Robbins, Solana Beach, CA (US)

(72) Inventor: Joshua Paul Jenkins-Robbins, Solana Beach, CA (US)

(73) Assignee: MY LIFE SAVINGS, LLC, Solana Beach, CA (US)

(21) Appl. No.: 13/604,271

(22) Filed: Sep. 5, 2012

Related U.S. Application Data
(63) Continuation of application No. 12/836,799, filed on Jul. 15, 2010, now abandoned.

(51) Int. Cl. G06Q 40/08

(52) U.S. Cl. 705/4

(57) ABSTRACT

A method, system, and computer program product for providing an analysis of potential life insurance coverage, includes receiving information regarding a current life insurance policy from a user. User information, such as demographic information and a health status are received. At least part of the user information is transmitted to a plurality of life insurance carriers via an API. Quotes are received for a plurality of potential life insurance policies from the plurality of life insurance carriers. The quotes are analyzed in comparison with the information regarding the current life insurance policy, and aspects of the comparison are displayed to the user.

### BACKGROUND

This Application is a continuation of U.S. patent application Ser. No. 12/836,799, filed Jul. 15, 2010, the contents of which are hereby incorporated by reference herein in their entirety.

### FIELD

The present disclosure relates generally to a system, method, and computer program product for analyzing existing and potential life insurance coverage and more specifically to providing a comparison of aspects of an existing life insurance policy to aspects of a potential replacement policy.

### BACKGROUND

Studies have shown that more than 70% of life insurance policyholders are overpaying for their coverage. There are number of reasons for this, a primary reason being that life insurance rates have fallen dramatically over the past 15 years. Currently there is no technology that allows a client to individually review their policy or to compare their existing policy with the benefits of a replacement policy. In today's current environment, the only consumer based technology on the web is term life insurance quotes. However, these term life insurance “quote engines” simply display rates for new coverage without regard to current coverage.

In addition, term life insurance represents only one type of life insurance sold in the United States. According to the American Council of Life Insurers (ACLI), 59% percent of the individual life insurance policies issued in 2006 were permanent policies. Types of permanent policies include Universal Life, Variable Universal Life, Whole Life, and Survivorship Universal Life.

One primary characteristic of all permanent life insurance is their inherent ability to build cash values. These cash values are akin to a savings account that can be drawn upon at a later date, borrowed against, used to pay premiums or exchanged into a replacement policy via a 1035 exchange. The performance/growth of these underlying cash values is determined by the policy type. Fixed policies fluctuate according to interest rates. Variable policies fluctuate according to the market performance and mutual fund sub accounts. Indexed policies fluctuate according to the performance of an entire index Standard & Poors (S&P) 500. Whole policies fluctuate according to interest rates and dividends paid on the underlying cash values and investments of the insurance carrier.

The performance of the policy's cash value has a directly inverse correlation to the premium amount required to keep that policy in force. The better the policy performs, the lower the required premium to keep the policy in force. The same is true for the opposite circumstance. When a policy performs poorly, a higher premium is required to keep the policy in force. In the past 30 years, the performance of most permanent policies, especially fixed products such as whole life and fixed universal life policies, has been poor. This is because the performance of these policies is tied to interest rates, which have fallen dramatically since the late 1980's. Indexed policies are variable in nature, their performance being tied to the markets. Thus, indexed policies are subject to market fluctuations and risk, which have been incredibly volatile over the past decade with the 2001 and 2008 market downturns.

Studies show that most policy owners are paying a premium amount that is inadequate to keep that policy “in force” and/or on track with the assumptions on which the policy was sold.

In addition, contacting an insurance agent to receive information regarding a potential life insurance policy introduces inherent bias into the process of selecting a life insurance carrier and policy.

Therefore, there is a need in the art for an individual to be able to evaluate their existing life insurance coverage and potential replacement life insurance coverage in a non-biased manner.

### SUMMARY

In light of the above described problems and unmet needs, aspects in accordance with the present invention include a method, system, and computer program product for providing an unbiased analysis of potential life insurance coverage, comprising the steps of, a processor for, and computer code for causing a computer to, respectively, receive information regarding a current life insurance policy from a user, receive user information, transmit the user information to a plurality of life insurance carriers via an API, receive quote information for a plurality of potential life insurance policies from the plurality of life insurance carriers, analyze the quote information and the information regarding the current life insurance policy, and display a comparison of aspects of the current life insurance policy to aspects of a potential life insurance policy.

The user information may include demographic factors, a health status, and a health rating when the current life insurance policy was obtained. The information regarding the current life insurance policy may include policy coverage, a cash surrender value, and premium costs. The analyzing may include determining a lowest base price for the plurality of potential insurance policies.

Aspects may further include displaying a comparison of aspects of the current life insurance policy to aspects of a plurality of potential life insurance policies and determining an impact on the lowest base price for the plurality of insurance policies if a 1035 exchange were made with the cash value for an existing permanent policy.

The information regarding the current life insurance policy may include an indication of whether the current life insurance policy includes survivorship benefits, and aspects may further include determining a second base price for the plurality of insurance policies having survivorship benefits, and determining an impact on the second base price for the plurality of insurance policies if a 1035 exchange were made with the cash value for the permanent policy.

Demographic factors may include gender, date of birth, height, and weight, and aspects may further include determining a health status category for the user based on a plurality of the demographic factors and comparing the determined health status to the health status received from the user.

Additional advantages and novel features of these aspects of the invention will be set forth in part in the description that follows, and in part will become more apparent to those skilled in the art upon examination of the following or upon learning by practice of the invention.

### BRIEF DESCRIPTION OF THE DRAWINGS

Various aspects of the systems and methods will be described in detail, with reference to the following figures, wherein:

FIG. 1 is a flow chart of a method for analyzing existing and potential life insurance coverage.

FIG. 2 is a flow chart illustrating exemplary questions to prompt a user to provide information for analyzing existing and potential life insurance coverage.

FIG. 3 is a conceptual block diagram illustrating the functionality of an exemplary apparatus.

FIG. 4 presents an exemplary system diagram of various hardware components and other features, for use in accordance with aspects of the present invention; and

FIG. 5 is a block diagram of various exemplary system components, in accordance with aspects of the present invention.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of insurance analysis systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

Studies show that most people are overpaying for their life insurance policy. Worse, many people will pay into a permanent policy and eventually lapse or surrender the policy back to the insurance carrier. In order to address the problems faced by so many, various aspects of a user's current life insurance policy can be identified across multiple types of policies along with the potential savings, guarantees, and other benefits available by replacing a current policy with a new policy. Guarantees may include a guaranteed premium schedule. Aspects further enable the assessment of an approximate health rating and the ongoing impact on future cost.

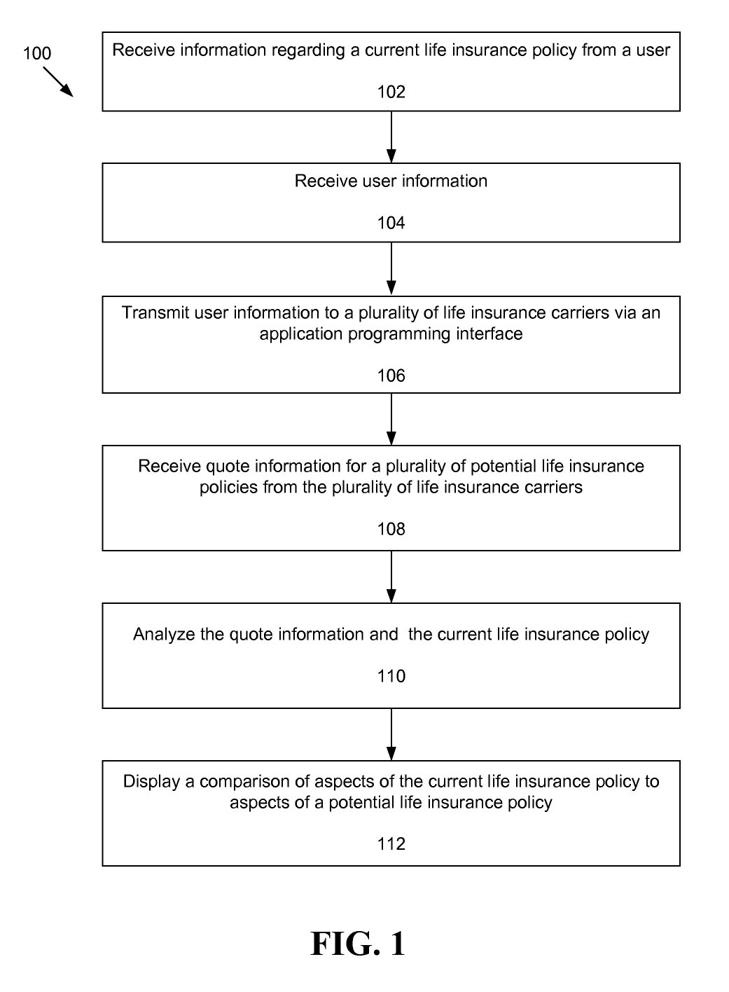

FIG. 1 is a flow chart 100 illustrating aspects of an insurance analysis system. Various types of life insurance policies may be considered. Among others, a life insurance policy may be a term life, universal life, whole life, and survivorship policy. A permanent policy may be any of a whole life, universal life, variable universal life, or survivorship life insurance policy. A “permanent” policy is used herein to refer to a life insurance policy that packages insurance coverage together with a savings component. The savings component is referred to interchangeably herein as a “cash value.” The cash value of such permanent life insurance policies can be added to, withdrawn, borrowed against, used to pay future premiums, or rolled over to a new permanent life insurance policy. The cash value can be rolled over into a new permanent life insurance policy via a 1035 exchange.

At 102, information is received from a user regarding a current life insurance policy. The life insurance policy may be a term policy or a permanent policy. The information may include a type of the policy, a face value of the policy or total coverage of the policy, a cash surrender value, premium costs, and a health rating when the policy was obtained. This information may be received, for example, via a web page.

At 104, user information is received. The information collected from the user may include gender, date of birth, height, weight, and a subjective evaluation of the user's current health rating. The self assessment of the health status may include an indication of whether the status is one of exceptional, excellent, above average, average, and below average.

If the insurance policy is a survivorship or second-to-die policy, the user information may also include the gender, date of birth, height, weight, and a subjective evaluation of a current health rating for the second individual in the policy.

At 106, the user information is transmitted to a plurality of life insurance carriers via an Application Programming Interface (API).

At 108, quote information is received for a plurality of potential life insurance policies from the plurality of life insurance carriers. This quote information may be obtained from an API filtered using the user information received at 104. The quote information may include, for example, a live real-time quote, including a base price, from a plurality of the nation's largest life insurance carriers. This information may be sorted based on price. This quote information may also be sorted based on carrier stability, using financial research or credit rating sources such as S&P and Moody's Investors Services. This quote information may be filtered using data collected from the user.

At 110, the quote information is analyzed along with the information regarding the current life insurance policy. For example, at least one quote may be identified based on a lowest base price. If the current life insurance policy is a permanent policy, a calculation can be made as to estimate the impact a 1035 exchange of the cash value of the current permanent policy would have on the base price for the identified quotes. An analysis may be made to determine at least one potential life insurance policy having a lowest base price, taking into account a 1035 exchange. This base price may be compared to aspects of the current life insurance policy, such as the cost of maintaining the policy. In most cases, a discounted base price may be obtained with a potential policy over the current policy, unless the user is much older than when they obtained the current policy or has experienced a significant deterioration in their health condition.

At 112, a comparison of aspects of the current life insurance policy to aspects of at least one potential life insurance policy is displayed, e.g. via a web page. The aspects may illustrate the potential savings, guarantees, and other benefits available if the user should decide to switch to a different type of policy and/or into a new policy. The aspects may include, for example, a cost to maintain the current policy compared with a cost to establish and maintain at least one potential policy. Additional information regarding the respective insurance carriers, and other aspects of the potential policy and the current policy may also be displayed.

This enables a user to evaluate the benefits of either maintaining their current policy or obtaining a replacement policy on their own.

If the current life insurance policy is a survivorship or second-to-die type policy, a determination may be made regarding a potential base price for a plurality of potential life insurance policies. Survivorship premium rates are not available via API. This determination can be made by analyzing the user information in order to generate an estimated survivorship premium rate. Therefore, a second base price is determined for a plurality of potential life insurance policies having survivorship benefits. Once these estimates are generated, a second calculation can be made regarding the estimated impact on the second base price for the plurality of potential insurance policies if a 1035 exchange were made with the cash value from the current life insurance policy.

Thus, as illustrated in connection with FIG. 1, the benefits of an existing cash value based life insurance policy can be analyzed and presented to a user using data received from a user, data pulled from API that has been filtered using the data collected from the user, data based on a cross reference of an estimated health status with a received health status, and data based on a determination of the effect of a 1035 exchange on potential policy costs.

The system may walk a user through an analysis of what type of insurance they will need, e.g. single or second-to-die, and how much insurance they will need. Cost options may be presented between term and permanent policies. The system can walk users through these items for a new policy alone, if users do not have a current policy.

The system may include a web based artificial intelligence engine designed to evaluate existing individual life insurance policies. Questions may be presented to a user via a web page. The user, for example, may be greeted by a friendly user interface that guides them through a series of questions. The web page may be configured to collect pertinent information from the user. The engine may use reflexive questioning to ensure that the information received from a user is relevant. Among others, the following types of questions may be presented to a user: “Does the user currently have life insurance coverage?,” “What type of policy is it (Term Life, Universal Life, Whole Life, Survivorship Universal Life)?,” “Would you like to evaluate your current coverage for potential savings OR see quotes for new coverage?” Further questions may be structured to receive answers regarding the insured's date of birth, the insured's state of residence, the insured's height/weight, the year in which the insured purchased the current policy, the name of the current insurance carrier, the face value of the current policy (i.e. coverage amount), the monthly or annual premium on the current policy, the amount of cash surrender value in the current policy, the insured's health rating when the policy was purchased, and the insured's self assessed current health rating when compared to when the policy was purchased. Similar information may be gathered for a second party in a second-to-die policy.

Depending on the answers, the client will fall into one of two categories: (1) those who do not have life insurance coverage or do not want to evaluate their current coverage and thus only want to see rates for new coverage, and (2) those who have a policy they would like to evaluate for potential savings.

For those who do not have life insurance, or those who may have a policy but do not want to evaluate their current policy, they will be guided through the process of obtaining quotes for both Term and Lifetime coverage. Lifetime coverage could be either Guaranteed Universal Life (for a single life) or Survivorship Universal Life (for second-to-die coverage). The quotes for single life Universal Life coverage can be based on real time data from a plurality of carriers. For example real time data can be pulled through an API provided by a third party for over 40 carriers. Quotes for Survivorship Universal Life coverage are not available via an API and, therefore, an estimate can be generated for each individual user based on the received information. This estimation can be based on a database compiled by running hundreds of quotes/insurance illustrations from a plurality of different carriers and then compiling them together to generate a blended rate estimate.

Because a Term Life insurance policy does not have a cash value, the only cost variable to be calculated is the ongoing premium of a new/replacement policy and the time frame for how long the premium will stay level (i.e. the length of the term 10, 15, 20 or 30 years) when compared to their current policy. Aspects may include pulling live quotes from top carriers, such as the top 40 carrier in the nation, pulling the least expensive quote, and determining the potential savings available. The least expensive quote is the quote having the lowest base price. In certain instances, there may or may not be a cheaper policy than a user's existing policy, however, the new policy may extend for a longer period. Among others information regarding policy terms, policy costs, policy values, and carrier stability for potential policies can be displayed by the system in a comparison with similar aspects of the user's existing life insurance policy.

When a user has an existing permanent life insurance policy, a series of calculations can be made to determine the approximate savings if that client were to replace the current policy with a new policy. The new policy may be a permanent policy, similar to the existing policy, or another type of policy. For example, an estimation can be made of the approximate ongoing premium, if the client were to 1035 exchange the cash value in their current policy to a new replacement policy. In addition, the estimate of the ongoing premium will be based on a guaranteed premium schedule to age 100 or 121, whereas many policies sold in the past few decades do not have a guaranteed premium schedule and/or the premium schedule is only guaranteed to an earlier age (i.e. 85/90/95).

Whether the client is evaluating a current policy or seeking new coverage altogether, their health rating will be a key variable in determining the premium amount and/or potential savings available to them. As the self assessed health status provided by the user may not be accurate, the accuracy of a health category may verified be determined based on the other received user information. Because a true health rating is only given by a carrier during underwriting, the described calculations and estimation can be made based on an estimation of the user's health status. This estimation can be based upon the user's assessment of their own health in combination with a cross referenced health assessment. For example, a database may be established using height and weight tables that define thresholds for underwriting health categories. A health status category may be determined for a user based on their height and weight. For example, the user's input of their height/weight may be cross referenced with life insurance carrier underwriting tables. These tables give maximum height/weight combinations that a carrier will allow for certain underwriting classes. This may act as the default so that a user will not be able to enter a better rate class if deemed impossible according to the height/weight tables.

This can be provided as a check to ensure the accuracy of the self assessed health status provided by the user so that the price quotes are consistent with an actual health status. If the user has estimated their health status to be in a higher category than the determined health status, the determined health status can be used as a default health status for calculations regarding potential life insurance policies. Otherwise, the user's self assessed health status may be applied in such calculations.

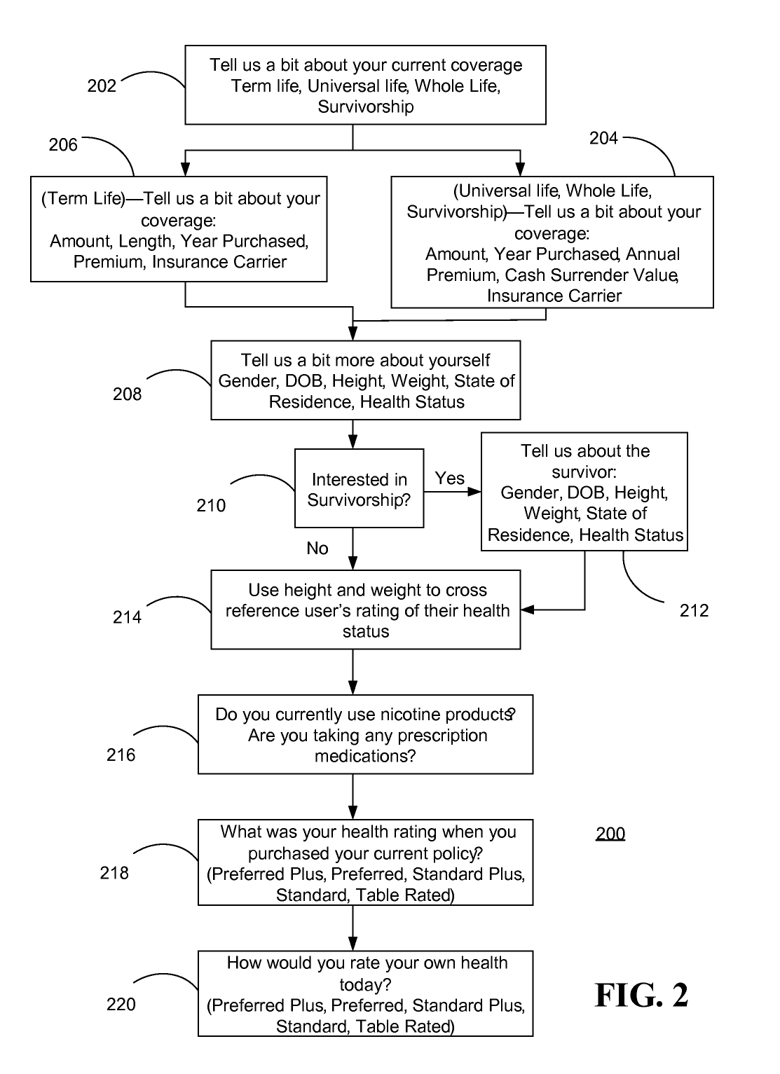

FIG. 2 illustrates an exemplary flow chart 200 for leading a user through questions to gather information to perform an analysis of their current life insurance policy in comparison with potential replacement policies. As described in more detail below, the questions may be provided to users via a webpage.

At 202, the user is asked about the type of their existing life insurance policy. Based on their response, the user is presented with questions at either 204 or 206. If the user's existing life insurance policy is a permanent policy, the user is presented with additional questions, at 204, about their coverage, such as the amount of coverage, the year the policy was purchased, the annual premium, the cash surrender value, and the name of the insurance carrier. These answers to these questions may be presented with drop down menus, for example. Also, the user may indicate that they are unsure of the premium amount and carrier.

In contrast, if the existing life insurance policy is a term life policy, the user is presented with additional questions, at 206, about their coverage, such as the amount of coverage, the length of the term, the year the policy was purchased, the monthly/annual premium, and the name of the insurance carrier.

At 208, the user is presented with additional questions to prompt the user to enter information about the individual covered by the policy. Among others, this information may include demographic information such as gender, date of birth, and state of residence, as well as other health related information such as height, weight, and a general health status.

At 210, the user is presented with a question to determine if their existing coverage includes survivorship provisions. If the existing coverage does include survivorship, the user is presented, at 212, with an additional set of demographic and health related questions for the second individual included in the survivorship policy. This may include the same gender, date of birth, height, weight, state of residence, and health status questions that were presented for the first individual.

Once the user has answered the questions in connection with 212 or in connection with 210, if the existing life insurance policy does not include survivorship provisions, an objective determination may be made, in 214, regarding the health status of the user based on information received at 208. This determination may be performed in order to verify the accuracy of the user's self assessed health status.

At 216, the user may be presented with additional lifestyle related questions. These may include questions regarding tobacco/nicotine use and/or use of prescription medications.

At 218, the user is asked about their health rating at the time that they purchased their current policy, and at 220, the user is asked about their current health status.

The user may then be presented with an option to see savings estimates and coverage options for potential life insurance policies.

The user may also be led through a series of questions in order to help them to determine an amount of coverage that is most suitable for their needs. For example, the user may be presented with questions regarding the amount of coverage that they would like. A user may enter an amount or may select a calculator tool to assist them in determining the amount of coverage that they need. The user may be asked about their needs, such as whether they want the life insurance policy to payout if they pass away or if both they and a second person pass away. This will indicate whether a single life plan or a survivorship/second-to-die plan is more likely to meet their needs. The user may be asked for information regarding themselves, and the potential second party if a survivorship plan was indicated as desirable. This information may be similar to that presented at 208 in FIG. 2. The user may likewise be presented with questions similar to 216 and 220. Then, a user may select an option to see cost and coverage options for potential life insurance policies. The user may be presented with this assistance to determine the type of coverage, for example, when they indicate that they do not currently have a life insurance policy.

Thus, aspects enable an individual to personally evaluate their life insurance coverage in comparison to other options for coverage as changes occur throughout their life. Change is an inevitable component, not only of every individual's health during their lifetime, but also to the economic basis that determine the value of permanent life insurance policies. When obtaining a life insurance policy, a policyholder is buying a policy that is based on a snapshot in time of their current health. However, a policyholder could have many changes in their health over time from quitting/starting smoking, losing/gaining weight or the development/eradication of an illness. Aspects allow users to answer a few questions and also rate their own health to see the potential savings (or premium increase) if they were to switch to a new policy. A comparison is provided of their current coverage and potential new coverage, taking into account any possible 1035 exchange. There is currently no way to receive a presentation of an analysis of the benefits of replacing an existing life insurance policy with potential new life insurance policies.

Furthermore, aspects remove the inherent bias that is introduced when policy options are presented to a user via an insurance agent.

For example, there are many inherent carrier biases that a life insurance agent can bring to any sale. The most glaring is the fact the agent can submit the life insurance case to the carrier(s) which he chooses. This poses a number of problems. First, the disparity in rates between carriers can be quite drastic. In fact, the rates can vary by more than 100% for the same client, with the same health rating, with the same date of birth. This is because carriers are constantly pricing themselves more or less competitive, for a particular class of risk, because they need to diversify their risk across a broad pool of lives. Price controls or fluctuations allow them to do this.

Additionally, a health rating is somewhat subjective. Certain carriers are admittedly more lenient with underwriting certain health conditions. While this is the right of the carrier, this could pose a problem for the client if the agent does not submit or shop the case out for multiple offers.

Furthermore, an agent could very well submit to a carriers) with whom he has an superior compensation contracts when compared to other carriers. This arbitrary choice can cost the client a tremendous amount of money, especially when drawn out over the lifetime of the policy.

Aspects described herein remove this bias by removing the sales side of the process with an unbiased computer based agent and bringing rates from a plurality of the nations top rated carriers and by allowing the client to assess their own health rating.

In addition, it is important to understand that agents make commissions as a percentage of the premium paid for a life insurance policy. This is true for every type of life insurance product whether term or permanent. This causes many agents to have a natural bias as to how they can fund the policy with as much premium as possible. This may cause them to select/propose a carrier that has a higher rate.

Permanent Life Insurance contracts have very favorable tax treatment of the internal cash values. Not only do they provide the coverage, they are often sold as a type of retirement vehicle or savings vehicle. This results in agents selling these products with “overfunded” premiums that result in a higher commission for an agent.

This bias can be removed in connection with the aspects described herein by configuring the system to calculate the rates for potential permanent insurance (whether single life or second-to-die) as the absolute minimum one can pay to guarantee the coverage to age 100. For both permanent and term life, these rates may be drawn in real time from over 40 of the nations largest most financially stable carriers and displays them according to price.

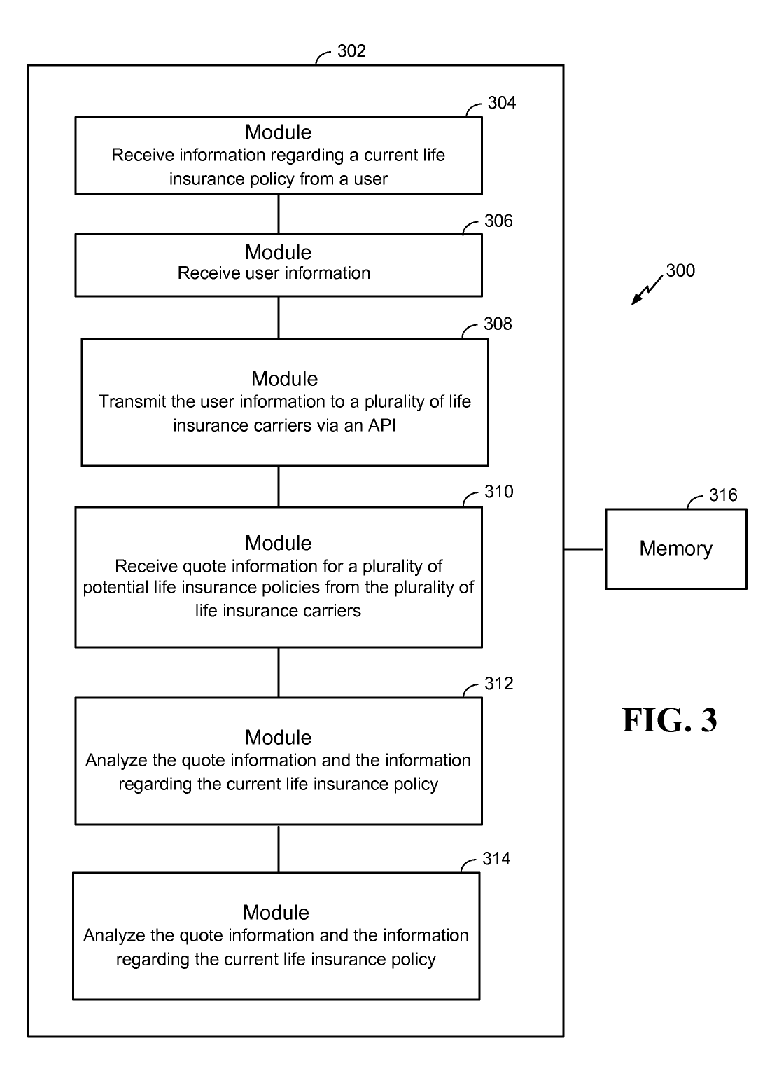

FIG. 3 is a conceptual block diagram 300 illustrating the functionality of an exemplary apparatus 302. The apparatus 302 includes a module 304 that receives information regarding a current life insurance policy from a user, a module 306 that receives user information, a module 308 that transmits the user information to a plurality of life insurance carriers via an API, a module 310 that receives quote information for a plurality of potential life insurance policies from the plurality of life insurance carriers, a module 312 that analyzes the quote information and the information regarding the current life insurance policy, and a module 314 that displays a comparison of aspects of the current life insurance policy to aspects of a potential life insurance policy. The apparatus may further include memory 316, or may include a connection to access memory 316.

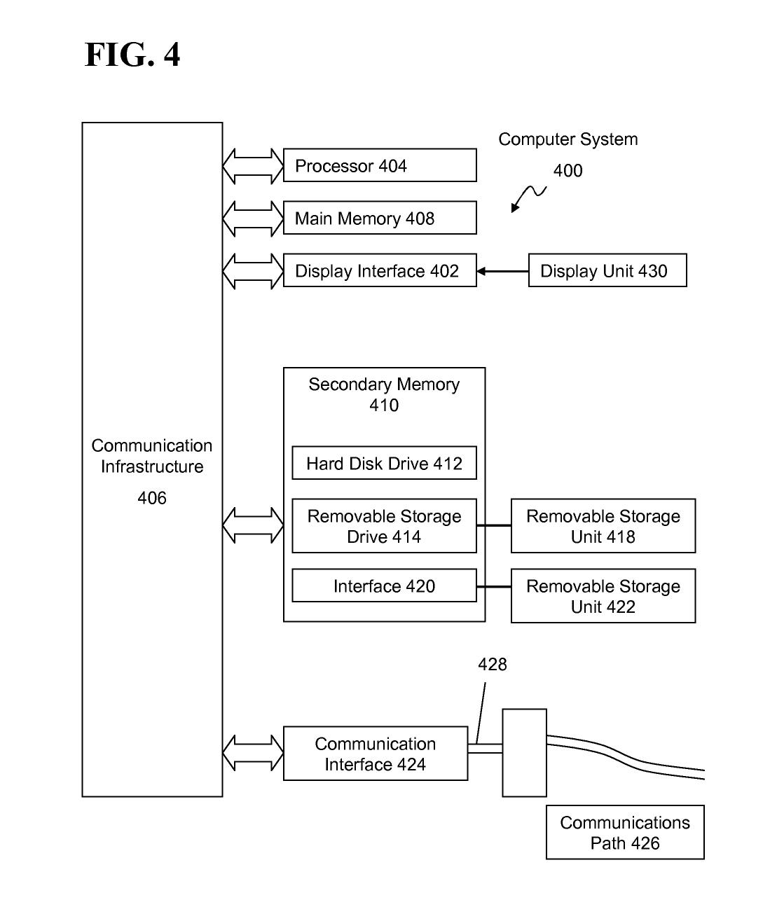

FIG. 4 presents an exemplary system diagram of various hardware components and other features, for use in accordance with aspects of the present invention. The present invention may be implemented using hardware, software, or a combination thereof and may be implemented in one or more computer systems or other processing systems. In one implementation, the invention is directed toward one or more computer systems capable of carrying out the functionality described herein. An example of such a computer system 400 is shown in FIG. 4.

Computer system 400 includes one or more processors, such as processor 404. The processor 404 is connected to a communication infrastructure 406 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 400 can include a display interface 402 that forwards graphics, text, and other data from the communication infrastructure 406 (or from a frame buffer not shown) for display on a display unit 430. Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well-known manner. Removable storage unit 418, represents a floppy disk, magnetic tape, optical disk, etc., which is read by and written to removable storage drive 414. As will be appreciated, the removable storage unit 418 includes a computer usable storage medium having stored therein computer software and/or data.

Alternatively, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical or other signals capable of being received by communications interface 424. These signals 428 are provided to communications interface 424 via a communications path (e.g., channel) 426. This path 426 carries signals 428 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 480, a hard disk installed in hard disk drive 470, and signals 428. These computer program products provide software to the computer system 400. The invention is directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 410 to perform the features of the present invention. Accordingly, such computer programs represent controllers of the computer system 400.

In an implementation where the invention is implemented using software, the software may be stored in a computer program product and loaded into computer system 400 using removable storage drive 414, hard drive 412, or communications interface 420. The control logic (software), when executed by the processor 404, causes the processor 404 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another implementation, the invention is implemented using a combination of both hardware and software.

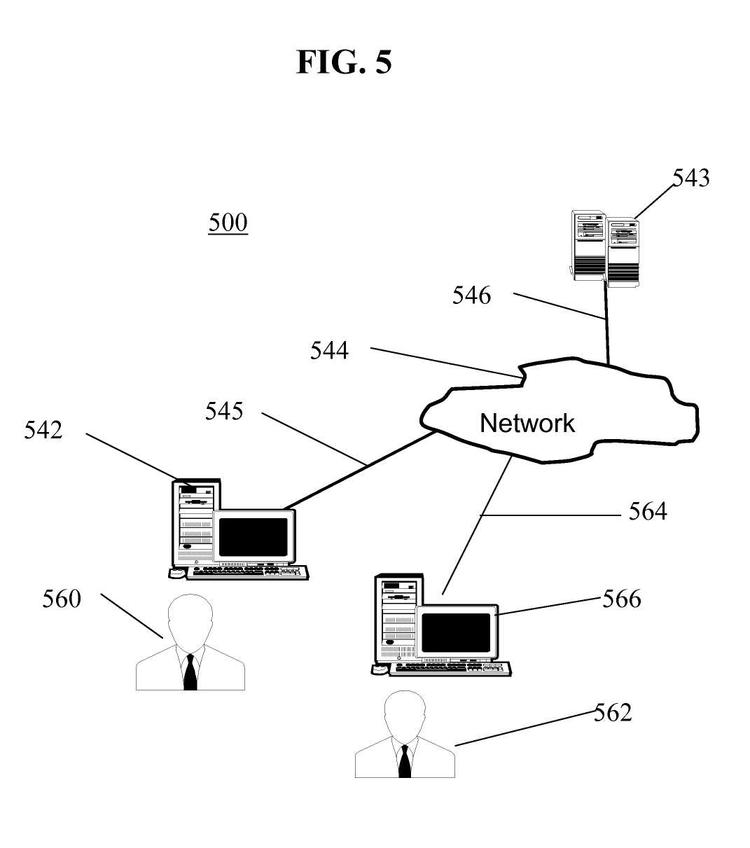

FIG. 5 is a block diagram of various aspects of exemplary system components. FIG. 4 shows a communication system 500 usable in accordance with aspects of the present invention. The communication system 500 includes one or more accessors 560, 562 (also referred to interchangeably herein as one or more “users”) and one or more terminals 542, 566. In one implementation, data for use in accordance with the present invention is, for example, input and/or accessed by users 560, 562 via terminals 542, 566, such as personal computers (PCs), minicomputers, mainframe computers, microcomputers, telephonic devices, or wireless devices, such as personal digital assistants (“PDAs”) or a hand-held wireless devices coupled to a server 543, such as a PC, minicomputer, mainframe computer, microcomputer, or other device having a processor and a repository for data and/or connection to a repository for data, via, for example, a network 544, such as the Internet or an intranet, and couplings 545, 546, 564. The couplings 545, 546, 564 include, for example, wired, wireless, or fiberoptic links. In another implementation, the method and system of the present invention operate in a stand-alone environment, such as on a single terminal.

While this invention has been described in conjunction with the exemplary implementations outlined above, various alternatives, modifications, variations, improvements, and/or substantial equivalents, whether known or that are or may be presently unforeseen, may become apparent to those having at least ordinary skill in the art. Accordingly, the exemplary implementations of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A method of providing an analysis of potential life insurance coverage, the method comprising:
receiving information regarding a current life insurance policy from a user;
receiving user information;
transmitting the user information to a plurality of life insurance carriers via an application programming interface;
receiving quote information for a plurality of potential life insurance policies from the plurality of life insurance carriers;
analyzing the quote information and the current life insurance policy; and
displaying a comparison of aspects of the current life insurance policy to aspects of a potential life insurance policy.

2. The method of claim 1, further comprising:
displaying a comparison of aspects of the current life insurance policy to aspects of a plurality of potential life insurance policies.

3. The method of claim 1, wherein the user information includes demographic factors, a health status, and a health rating when the current life insurance policy was obtained.

4. The method of claim 3, wherein the information regarding the current life insurance policy includes policy coverage, a cash surrender value, and premium costs.

5. The method of claim 4, wherein the analyzing includes determining a lowest base price for the plurality of potential insurance policies.

6. The method of claim 5, wherein the current life insurance policy is a permanent policy having a cash value.

7. The method of claim 6, further comprising:
determining an impact on the lowest base price for the plurality of insurance policies if a 1035 exchange were made with the cash value for the permanent policy.

8. The method according to claim 7, wherein the information regarding the current life insurance policy includes an indication of whether the current life insurance policy includes survivorship benefits, the method further comprising:
determining a second base price for the plurality of insurance policies having survivorship benefits.

9. The method of claim 8, further comprising:
determining an impact on the second base price for the plurality of insurance policies if a 1035 exchange were made with the cash value for the permanent policy.

10. The method of claim 3, wherein the demographic factors include gender, date of birth, height, and weight, the method further comprising:
determining a health status category for the user based on a plurality of the demographic factors; and
comparing the determined health status to the health status received from the user.

11. A system for providing an analysis of potential life insurance coverage, the system comprising:
a processor;
a user interface functioning via the processor; and
a repository accessible by the processor; wherein the processor is configured to:
receive information regarding a current life insurance policy from a user;
receive user information;
transmit the user information to a plurality of life insurance carriers via an application programming interface;
receive quote information for a plurality of potential life insurance policies from the plurality of life insurance carriers;
analyze the quote information and the current life insurance policy; and
display a comparison of aspects of the current life insurance policy to aspects of a potential life insurance policy.

12. The system of claim 11, wherein the current life insurance policy is a permanent policy having a cash value, and wherein the information regarding the current life insurance policy includes policy coverage, a cash surrender value, and premium costs.

13. The system of claim 12, wherein the processor is further configured to:
determine a lowest base price for the plurality of potential insurance policies; and
determine an impact on the lowest base price for the plurality of insurance policies if a 1035 exchange were made with the cash value for the permanent policy.

14. The system according to claim 13, wherein the information regarding the current life insurance policy includes an indication of whether the current life insurance policy includes survivorship benefits, wherein the processor is further configured to:
determine a second base price for the plurality of insurance policies having survivorship benefits.

15. The system of claim 14, wherein the processor is further configured to:
determine an impact on the second base price for the plurality of insurance policies if a 1035 exchange were made with the cash value for the permanent policy.

16. A computer program product comprising a non-transitory computer usable medium having control logic stored therein for causing a computer to provide an analysis of potential life insurance coverage, the control logic comprising code for causing the computer to:
receive information regarding a current life insurance policy from a user;
receive user information;
transmit the user information to a plurality of life insurance carriers via an application programming interface;
receive quote information for a plurality of potential life insurance policies from the plurality of life insurance carriers;
analyze the quote information and the current life insurance policy; and
display a comparison of aspects of the current life insurance policy to aspects of a potential life insurance policy.

17. The computer program product of claim 16, wherein the current life insurance policy is a permanent policy having a cash value, and wherein the information regarding the current life insurance policy includes policy coverage, a cash surrender value, and premium costs.

18. The computer program product of claim 17, wherein the control logic further comprises code for causing the computer to:
determine a lowest base price for the plurality of potential insurance policies; and
determine an impact on the lowest base price for the plurality of insurance policies if a 1035 exchange were made with the cash value for the permanent policy.

19. The computer program product according to claim 18, wherein the information regarding the current life insurance policy includes an indication of whether the current life insurance policy includes survivorship benefits, wherein the control logic further comprises code for causing the computer to:
determine a second base price for the plurality of insurance policies having survivorship benefits.

20. The computer program product of claim 19, wherein the control logic further comprises code for causing the computer to:
determine an impact on the second base price for the plurality of insurance policies if a 1035 exchange were made with the cash value for the permanent policy.
